(19) United States
(12) Patent Application Publication
(10) Pub. No.: US 2016/0376481 A1
(43) Pub. Date: Dec. 29, 2016

(54) ADHESIVE COMPOSITION FOR USE IN STEEL PLATES, AND THERMOPLASTIC RESIN COATED STEEL PLATE USING SAME

(71) Applicant: PANASONIC INTELLECTUAL PROPERTY MANAGEMENT CO., LTD., Osaka-shi (JP)

(72) Inventors: Shigeharu FUKUZAWA, Osaka (JP); Yu CHEN, Osaka (JP)

(21) Appl. No.: 15/039,523

(22) PCT Filed: Dec. 3, 2014
(86) PCT No.: PCT/JP2014/006037

§ 371 Date: May 26, 2016

(30) Foreign Application Priority Data
Dec. 10, 2013 (JP) 2013-255494

(51) Int. Cl. C09J 133/10; C09J 11/04; B05D 1/02; B05D 1/00; B05D 1/28; B05D 1/18; C09J 9/00; C23F 11/18

(52) U.S. Cl. CPC C09J 133/10; C09J 9/00; C09J 11/04; C23F 11/184; B05D 1/005; B05D 1/28; B05D 1/18; B05D 1/02; C08K 3/32

(57) ABSTRACT

In an adhesive composition for steel plate containing a rust preventive, a thermoplastic resin, and a thermosetting resin, the rust preventive is either of aluminum tripolyphosphate or magnesium phosphate, the thermoplastic resin is an acrylic resin, and the thermosetting resin is a phenol resin and an epoxy resin.

### TECHNICAL FIELD

The present invention relates to an adhesive composition for steel plate and a thermoplastic resin-coated steel plate using the same.

### BACKGROUND ART

A vinyl chloride-coated steel plate that is one of the thermoplastic resin-coated steel plates has been widely used in the fields of home electric appliances and building materials due to its high processability and design property. A vinyl chloride-coated steel plate has also been used, for example, in external wall materials or members which are required to exhibit corrosion resistance in addition to interior wall materials including a wall material for a prefabricated bath and a door material. Generally, a vinyl chloride-coated steel plate has been fabricated by forming a cured film on the surface of a steel plate by curing a vinyl chloride paint coated thereon or by laminating a vinyl chloride film on a steel plate, and an adhesive is used in order to bond the steel plate with the vinyl chloride film (or cured film).

Hitherto, the adhesive has been extensively investigated since a vinyl chloride-coated steel plate is required to exhibit high adhesive property or heat resistance. For example, an adhesive for vinyl chloride-coated steel plate composed of an acrylic resin and an epoxy resin (Patent Literature 1) or an adhesive for vinyl chloride-coated steel plate composed of an acrylic resin, an epoxy resin, and a phenol resin (Patent Literature 2) has been proposed. The adhesive property of the vinyl chloride film to a steel plate is enhanced by coating these adhesives for vinyl chloride-coated steel plate on the surface of a steel plate and then curing it using a curing agent. In addition, nitrile rubber or the like as a flexibility imparting agent is added to the adhesive for vinyl chloride-coated steel plate described in Patent Literature 2 to also enhance the impact resistance at a low temperature.

However, the adhesive for vinyl chloride-coated steel plate described in Patent Literature 1 does not necessarily exhibit sufficient performance such as a peel strength and adhesive property, and a possibility that peeling off of the vinyl chloride film or material failure is generated is pointed out. In addition, the adhesive for vinyl chloride-coated steel plate described in Patent Literature 2 requires a relatively high thermal activation temperature of higher than 170° C. for bonding the steel plate with the vinyl chloride film, and thus it is pointed out that film breakage is likely to occur. There is room for improvement in productivity since it is required to lower the speed of the production line for the suppression of film breakage.

In order to solve these problems, an adhesive composition has been proposed which contains a silane coupling agent having an epoxy group at from 0.5 part by weight to 10 parts by weight with respect to 100 parts by weight of a polyester resin, aluminum dihydrogen tripolyphosphate at from 0.5 part by weight to 10 parts by weight (net weight) with respect to 100 parts by weight of a polyester resin, and a polyisocyanate compound having two or more isocyanate groups in the molecule (Patent Literature 3). The polyester resin described in Patent Literature 3 is a linear saturated thermoplastic polyester resin that is composed of an aromatic dicarboxylic acid and a diol component and has a hydroxyl group at the terminal of the molecular chain and a weight average molecular weight of from 15,000 to 70,000.

According to the adhesive composition described in Patent Literature 3, it is possible to improve the water resistance of the adhesive layer and to realize excellent adhesive characteristics at a low thermal activation temperature since aluminum dihydrogen tripolyphosphate is contained therein.

### CITATION LIST

### Patent Literatures

Patent Literature 1: JP 1984-37034 B2

Patent Literature 2: JP 1983-179274 A

Patent Literature 3: JP 1990-235978 A

### SUMMARY OF INVENTION

### Technical Problem

Meanwhile, a galvanized steel plate, a steel plate coated with an alloy of zinc, aluminum, magnesium, and the like are used as the steel plate in the vinyl chloride-coated steel plate. In particular, a galvanized steel plate is used in a wide range of applications due to its high versatility. Galvanization makes it possible to thicken the film, and thus a galvanized steel plate exhibits superior corrosion resistance as compared to a painted steel plate.

On the other hand, there is a problem that the steel plate is easily covered with rust and the vinyl chloride film is peeled off in a case in which the vinyl chloride-coated steel plate is scratched at the time of processing or water has penetrated through the cut surface.

The invention has been made in view of the circumstances as described above, and an object thereof is to provide an adhesive composition for steel plate capable of exerting rust resistance even on the cut surface while maintaining adhesive property and a thermoplastic resin-coated steel plate in which a steel plate is bonded with the cured film or film of a thermoplastic resin by this adhesive composition.

### Solution to Problem

To achieve the above object, an adhesive composition for steel plate of the invention comprises: a rust preventive; a thermoplastic resin; and a thermosetting resin, wherein the rust preventive is either of aluminum tripolyphosphate or magnesium phosphate, the thermoplastic resin is an acrylic resin, and the thermosetting resin is a phenol resin and an epoxy resin.

In addition, in a thermoplastic resin-coated steel plate of the invention, a steel plate is bonded with a cured film or film of a thermoplastic resin via the adhesive composition for steel plate.

### Advantageous Effects of Invention

According to the adhesive composition for steel plate of the invention, it is possible to provide an adhesive composition for steel plate capable of exerting rust resistance even on the cut surface while maintaining adhesive property and a thermoplastic resin-coated steel plate in which a steel plate is bonded with the cured film or film of a thermoplastic resin by this adhesive composition.

In addition, according to the thermoplastic resin-coated steel plate of the invention, it is possible to exert rust resistance even on the cut surface in addition to favorable adhesive property of the cured film or film of a thermoplastic resin to the steel plate.

### Description of Embodiments

Hereinafter, the adhesive composition for steel plate and the thermoplastic resin-coated steel plate using the same of the invention will be described in detail.

The adhesive composition for steel plate is an adhesive composition containing a rust preventive, a thermoplastic resin, and a thermosetting resin. In this adhesive composition, the rust preventive is either of aluminum tripolyphosphate or magnesium phosphate, the thermoplastic resin is an acrylic resin, and the thermosetting resin is a phenol resin and an epoxy resin. The thermoplastic resin-coated steel plate is one in which a steel plate is bonded with the cured film or film of a thermoplastic resin via the adhesive composition described above.

Aluminum tripolyphosphate or magnesium phosphate forms a protective film on the surface of the steel plate so as to significantly improve the rust resistance of the thermoplastic resin-coated steel plate, particularly the rust resistance of the cut surface. In addition, in a case in which the steel plate is subjected to metal plating, aluminum tripolyphosphate or magnesium phosphate is likely to form a coating film to protect the plating through a reaction with the metal ion in metal plating. Such use of aluminum tripolyphosphate or magnesium phosphate as a rust preventive particularly attracts attention in the adhesive composition.

Aluminum tripolyphosphate is a fine white powder poorly soluble in water and a layered compound in which plate-like crystals overlap one another, and the surface thereof is passivated by gradually eluting the tripolyphosphate ion (P₃O₁₀⁵⁻) to chelate iron, zinc, or the like.

The surface of aluminum tripolyphosphate can be modified with another ionic compound such as silica, zinc, magnesium, or calcium. Those of which the surface is modified with magnesium or silica are suitably used in the case of using a hot-dip galvanized steel plate as the steel plate.

Examples of the dispersed particle size of aluminum tripolyphosphate may include a dispersed particle size of about from 1 μm to 30 μm and preferably about from 1 μm to 10 μm.

Meanwhile, examples of magnesium phosphate may include a compound such as magnesium zinc phosphate, magnesium primary phosphate, magnesium secondary phosphate, magnesium tertiary phosphate, or magnesium phosphite. The particle surface of magnesium phosphate can be modified with an ionic compound such as silica, zinc, magnesium, or calcium in the same manner as aluminum tripolyphosphate. Magnesium phosphate suppresses the corrosion of metal as the magnesium ion is eluted from the particle and the eluted magnesium ion forms a protective coating film on the surface of steel plate.

Examples of the dispersed particle size of magnesium phosphate may include about from 1 μm to 30 μm and preferably about from 1 μm to 10 μm.

Here, the dispersed particle size refers to an average particle size of the particles (secondary particles) dispersed in the adhesive composition in a state in which the particles (primary particles) of aluminum tripolyphosphate or magnesium phosphate are aggregated.

Examples of the content of the aluminum tripolyphosphate or magnesium phosphate in the adhesive composition may preferably include a range of from 14.0% by mass to 25.0% by mass with respect to the total nonvolatile component amount of the adhesive composition. More favorable rust resistance is obtained when the content is within the range of from 14.0% by mass to 25.0% by mass. The rust resistance is not sufficiently exerted in some cases when the content is out of the range of from 14.0% by mass to 25.0% by mass.

The thermoplastic resin is used as the base material of the adhesive composition.

An acrylic resin is used as the thermoplastic resin. An acrylic resin contains an ester of (meth)acrylic acid as a main component and is obtained by polymerizing a methyl methacrylate monomer, a polyfunctional acrylic monomer, prepolymer, or polymer, or the like.

Examples of the ester of (meth)acrylic acid may include methyl (meth)acrylate, ethyl (meth)acrylate, and n(or iso)-propyl (meth)acrylate. In addition, n(or iso or tert)-butyl (meth)acrylate, cyclohexyl (meth)acrylate, 2-ethylhexyl (meth)acrylate, and lauryl (meth)acrylate are also exemplified.

In addition, the acrylic resin may contain another monomer component that is copolymerizable with the ester of (meth)acrylic acid described above as a copolymerizable monomer if necessary for the purpose of improving the characteristics of the resin film or the cured film.

Examples of the copolymerizable monomer may include a styrene such as styrene, a-methyl styrene, or tert-butylstyrene. In addition, an unsaturated carboxylic acid such as itaconic acid, fumaric acid, maleic acid, and any half-ester thereof, (meth)acrylamide, N-methylolacrylamide, and dimethylaminoethyl (meth)acrylate are exemplified. In addition, a hydroxyl group or polar group-containing monomer such as vinylpyrrolidone, β-hydroxyethyl (meth)acrylate, polyethylene glycol (meth)acrylate, and any methoxylated product thereof, or a monoester of a polyhydric alcohol and (meth)acrylic acid is exemplified. In addition, a vinyl ester such as vinyl acetate or vinyl versatate, vinyl ethers having various kinds of alkyl groups, an α-olefin such as ethylene or propylene, a halide such as vinyl chloride, vinylidene chloride, or vinylidene fluoride, and divinyl benzene are exemplified. Furthermore, a diallyl compound, a di(meth)acrylate, a tri(meth)acrylate, and a vinyl silane are also exemplified.

It is possible to prepare a thermoplastic acrylic resin by copolymerizing these copolymerizable monomers with an ester of (meth)acrylic acid. The thermoplastic acrylic resin dissolves when heat is applied thereto, and thus it is firmly bonded to a thermoplastic resin such as a vinyl chloride film to be used for top coat at the time of molding.

The amount of the thermoplastic resin blended is not particularly limited, but it is preferably from 20 parts by mass to 100 parts by mass. The adhesive property is favorable when the amount of the thermoplastic resin blended is within the above range.

The thermosetting resin further enhances the adhesive property of the adhesive composition by being concurrently used with a thermoplastic resin.

A phenol resin and an epoxy resin are used as the thermosetting resin.

A phenol resin is firmly bonded to a steel plate as the hydroxyl group or the like of its skeleton reacts with the hydroxyl group on the surface or the like of the steel plate.

Examples of the phenol resin may include a novolak type phenol resin such as a phenol novolak resin and an aralkyl type phenol resin such as an unsubstituted phenol aralkyl resin, a biphenylene type phenol aralkyl resin, or a naphthol aralkyl resin. In addition, a dicyclopentadiene type phenol resin such as a dicyclopentadiene type phenol novolak resin or a dicyclopentadiene type naphthol novolak resin and a triphenylmethane type phenol resin are exemplified. In addition, a para-xylylene and/or meta-xylylene-modified phenol resin, a melamine-modified phenol resin, a cyclopentadiene-modified phenol resin, a phenol resin obtained by copolymerizing two or more kinds thereof, and the like are exemplified. Furthermore, a natural resin-modified phenol resin in which a natural resin such as linseed oil or terpene resin is present in the structure is exemplified. These may be used singly or as a mixture of two or more kinds thereof.

Examples of the epoxy resin may include a bisphenol A type epoxy resin, a bisphenol F type epoxy resin, a biphenyl type epoxy resin, a tetramethyl biphenyl type epoxy resin, and a phenol novolak type epoxy resin. In addition, a cresol novolak type epoxy resin, a triphenylmethane type epoxy resin, a tetraphenyl ethane type epoxy resin, a dicyclopentadiene-phenol addition reaction type epoxy resin, and a phenol aralkyl type epoxy resin are exemplified. In addition, a naphthol novolak type epoxy resin, a naphthol aralkyl type epoxy resin, a naphthol-phenol-cocondensed novolak type epoxy resin, and a naphthol-cresol-cocondensed novolak type epoxy resin are exemplified. Furthermore, an aromatic hydrocarbon formaldehyde resin-modified phenol resin type epoxy resin, a biphenyl-modified novolak type epoxy resin, and the like are exemplified. These may be used singly or as a mixture of two or more kinds thereof.

Examples of the epoxy equivalent of the epoxy resin may preferably include an epoxy equivalent of from 100 eq/g to 1000 eq/g.

The epoxy group in the epoxy resin is basically a bifunctional epoxy group, but it may be a polyfunctional type epoxy group of trifunctional or higher-functional. The crosslinking density is improved and the heat resistant performance is improved when the number of functional groups increases, and it is possible to lower the viscosity when the molecular weight decreases.

In addition, it is possible to add a catalyst, a crosslinking agent, or the like to the epoxy resin in order to improve the physical properties of the resin as long as it does not inhibit the rust resistance of aluminum tripolyphosphate or magnesium phosphate. Examples of the catalyst may include imidazole and a tertiary amine. Examples of the crosslinking agent may include an amine compound and a carboxylic acid-containing acrylic resin.

The amount of the thermosetting resin blended is not particularly limited, but it is preferably from 20 parts by mass to 100 parts by mass. The adhesive property is favorable when the amount of a thermosetting resin blended is within the above range.

The other components of the adhesive composition are not particularly limited as long as they do not inhibit the rust resistance of aluminum tripolyphosphate or magnesium phosphate. Examples thereof may include a diluting solvent, an inorganic filler, a pigment component, a surfactant, an antibacterial agent, an antifungal agent, a matting agent, a defoamer, a thickener, an anti-settling agent, a leveling agent, a dispersant, a heat stabilizer, a ultraviolet absorber, and a wax component.

Examples of the diluting solvent may include xylene, methyl ethyl ketone, ethyl acetate, n-butyl alcohol, and another hydrocarbon, a ketone, an ester, an alcohol, and water. These may be used singly or as a mixture of two or more kinds thereof.

Examples of the inorganic filler may include talc and silica. These may be used singly or as a mixture of two or more kinds thereof.

Such an adhesive composition is used by being coated or the like on a steel plate.

The coating amount of the adhesive composition can be set, for example, such that the adhesive thickness before drying is in a range of from 3 μm to 30 μm. When the coating amount is within the above range, it is possible to sufficiently support the adhesive composition on the surface of the steel plate and it is effective to enhance the retainability of adhesive property and rust resistance.

As the coating method, a method known in the prior art can be applied. Examples thereof may include flow coater, roll coater, curtain coating, knife coating, spin coating, table coating, sheet coating, sheet-fed coating, die coating, and bar coating. In addition, a blowing method, an airless spray method, an air spray method, brush coating, troweling, a dipping method, and a pulling method are exemplified. These coating methods may be automated, or coating by these methods may be manually conducted.

A thermoplastic resin-coated steel plate can be obtained as a steel plate is bonded with the cured film or film of a thermoplastic resin via such an adhesive composition for steel plate. This thermoplastic resin-coated steel plate exhibits excellent rust resistance and can exert rust resistance even on the cut surface while retaining adhesive property. The rust resistance has not only immediate effectivity but also retainability.

Examples of the steel plate may include a galvanized steel plate, a hot-dip galvanized steel plate, and a steel plate coated with an alloy of zinc, aluminum, magnesium, and the like.

Among these, a hot-dip galvanized steel plate is practically preferable since the film formed by galvanization can be thickened so that the corrosion resistance of the hot-dip galvanized steel plate is superior as compared to a painted steel plate.

Examples of the thermoplastic resin to form a cured film may include a vinyl chloride resin, an ABS resin, a polyethylene resin, a polypropylene resin, and a polyethylene terephthalate resin. In particular, a vinyl chloride resin is practically preferable as it exhibits excellent water resistance.

Examples of the film thickness of the cured film may preferably include a range of from 20 μm to 500 μm. Examples of the method for forming this cured film may include a method to form a cured film by curing a thermoplastic resin coated on the surface of a steel plate and a method to form a cured film by coating a thermoplastic resin on the surface of a steel plate through extrusion molding of the steel plate and the thermoplastic resin and then curing this resin.

Examples of the thermoplastic resin film may include a vinyl chloride film, an acrylic resin film, a polyethylene film, a polypropylene film, and a polyethylene terephthalate film. In particular, a vinyl chloride film is practically preferable as it exhibits excellent water resistance.

Examples of the film thickness of the thermoplastic resin film may preferably include a range of from 20 μm to 500 μm.

Hereinafter, Examples will be described, but the adhesive composition for steel plate and the thermoplastic resin-coated steel plate using the same are not limited to Examples.

### EXAMPLES

### Example 1

Forty parts by mass of an acrylic resin (A-801 manufactured by DIC Corporation, NV: 50%) as the thermoplastic resin, 20 parts by mass of a resol type phenol resin (3011 manufactured by DIC Corporation, NV: 100%) and 20 parts by mass of an epoxy resin (YD-902 manufactured by NIPPON STEEL & SUMIKIN CHEMICAL CO., LTD., NV: 100%) as the thermosetting resin, 20 parts by mass of aluminum tripolyphosphate (G105 manufactured by TAYCA) as the rust preventive, and 60 parts by mass of xylene and 50 parts by mass of methyl ethyl ketone (MEK) as the diluting solvent were mixed together, beads having a diameter of 2 mm as the inorganic filler were added thereto, and the mixture was dispersed at room temperature for 3 hours using a paint shaker, thereby obtaining an adhesive composition. At this time, the adhesive composition was prepared so as to have a dispersed particle size of aluminum tripolyphosphate of 30 μm or less.

This adhesive composition was coated on a hot-dip galvanized steel plate which had a sheet thickness of 0.5 mm and a plating basis weight of 150 g/m² per one side and was subjected to a coating type chromate treatment using a bar coater so as to have an adhesive thickness of from 5 to 10 μm, baked for 3 minutes in a drying oven at 200° C., and cooled, and a vinyl chloride film was then laminated on the surface of the steel plate and press molded at 200° C., thereby fabricating a vinyl chloride-coated steel plate. Incidentally, the chromate treatment is a chemical conversion treatment for improving the adhesive property of the paint or the adhesive by treating the surface of the steel plate with a chromate salt to form an oxide coating film.

### Example 2

A vinyl chloride-coated steel plate was fabricated in the same manner as in Example 1 except that the rust preventive was changed from aluminum tripolyphosphate to magnesium phosphate (PMG manufactured by KIKUCHI COLOR & CHEMICALS CORPORATION).

### Example 3

A vinyl chloride-coated steel plate was fabricated in the same manner as in Example 1 except that the amount of aluminum tripolyphosphate blended was changed from 20 parts by mass to 10 parts by mass.

### Example 4

A vinyl chloride-coated steel plate was fabricated in the same manner as in Example 2 except that the amount of magnesium phosphate blended was changed from 20 parts by mass to 10 parts by mass.

### Comparative Example 1

A vinyl chloride-coated steel plate was fabricated in the same manner as in Example 1 except that the rust preventive was changed from aluminum tripolyphosphate to zinc phosphate (D-1 manufactured by KIKUCHI COLOR & CHEMICALS CORPORATION).

### Comparative Example 2

A vinyl chloride-coated steel plate was fabricated in the same manner as in Example 1 except that a rust preventive was not blended and talc (L-1 manufactured by Nippon Talc Co., Ltd.) as the inorganic filler was blended at 20 parts by mass.

### Comparative Example 3

A vinyl chloride-coated steel plate was fabricated in the same manner as in Example 1 except that a rust preventive was not blended and silica (AEROSIL 200 manufactured by NIPPON AEROSIL CO., LTD) as the inorganic filler was blended at 20 parts by mass.

### Comparative Example 4

A vinyl chloride-coated steel plate was fabricated in the same manner as in Example 1 except that both of a rust preventive and an inorganic filler were not blended.

With regard to the vinyl chloride-coated steel plates obtained in Examples and Comparative Examples, the adhesive property and rust resistance of the samples for evaluation obtained in Examples and Comparative Examples were evaluated. The criteria for evaluation are as follows.

### <Adhesive Property>

Test pieces were cut out from the vinyl chloride-coated steel plates obtained in Examples and Comparative Examples, these test pieces were immersed in boiling water for 1 hour and then subjected to the test by the cross-cut method based on JIS K5600, and the adhesive property of the vinyl chloride film was judged according to the following criteria.
◯: Vinyl chloride film is not peeled off and adhesive property is favorable.
Δ: Vinyl chloride film is partially peeled off. (not applicable) ×: Vinyl chloride film is wholly peeled off. (not applicable)

### <Rust Resistance>

Test pieces were cut out from the vinyl chloride-coated steel plates obtained in Examples and Comparative Examples and subjected to the salt spray test for 1,000 hours in conformity with JIS Z2371, and the generation of rust at the cut surface portion and cross-cut portion of the test pieces was evaluated according to the following criteria.
◯: Width of cross-cut portion peeled off is within 1 mm.
Generation of rust is not observed at cut surface portion or cross-cut portion.
×: Width of cross-cut portion peeled off is 1 mm or more.
Generation of rust is observed at cut surface portion or cross-cut portion.

The evaluation results are presented in Table 1.

TABLE 1

| | | | | | | | | Compara- | Compara- | Compara- | Compara- |
|---|---|---|---|---|---|---|---|---|---|---|---|
| | | | NV* | | | | | tive | tive | tive | tive |
| | | | (%) | Example 1 | Example 2 | Example 3 | Example 4 | Example 1 | Example 2 | Example 3 | Example 4 |
| Blending | Thermoplastic | Acrylic resin | 60 | 40 | 40 | 40 | 40 | 40 | 40 | 40 | 40 |
| composi- | resin | | | | | | | | | | |
| tion | Thermosetting | Phenol resin | 100 | 20 | 20 | 20 | 20 | 20 | 20 | 20 | 20 |
| (parts by | resin | Epoxy resin | 100 | 20 | 20 | 20 | 20 | 20 | 20 | 20 | 20 |
| mass) | Diluting | Xylene | | 60 | 60 | 60 | 60 | 60 | 60 | 60 | 60 |
| | solvent | Methyl ethyl | | 50 | 50 | 50 | 50 | 50 | 50 | 50 | 50 |
| | | ketone | | | | | | | | | |
| | | (MEK) | | | | | | | | | |
| | Rust preventive | Aluminum | | 20 | | 10 | | | | | |
| | | tripolyphosphate | | | | | | | | | |
| | | Magnesium | | | 20 | | 10 | | | | |
| | | phosphate | | | | | | | | | |
| | | Zinc | | | | | | 20 | | | |
| | | phosphate | | | | | | | | | |
| | Inorganic | Talc | | | | | | | 20 | | |
| | filler | Silica | | | | | | | | 20 | |

| | | | | | | | | |
|---|---|---|---|---|---|---|---|---|
| Total amount | 210 | 210 | 200 | 200 | 210 | 210 | 210 | 190 |
| NV* (%) | 38.1 | 38.1 | 35.0 | 35.0 | 38.1 | 38.1 | 38.1 | 31.6 |
| Content of rust preventive or | 25.0 | 25.0 | 14.3 | 14.3 | 25.0 | 25.0 | 25.0 | 0.0 |
| inorganic filler with respect to total NV | | | | | | | | |
| amount of adhesive composition for | | | | | | | | |
| steel plate (%) | | | | | | | | |
| Kind of steel plate | Hot-dip | Hot-dip | Hot-dip | Hot-dip | Hot-dip | Hot-dip | Hot-dip | Hot-dip |
| | galvanized | galvanized | galvanized | galvanized | galvanized | galvanized | galvanized | galvanized |
| | steel plate | steel plate | steel plate | steel plate | steel plate | steel plate | steel plate | steel plate |
| Adhesive property | ◯ | ◯ | ◯ | ◯ | ◯ | ◯ | ◯ | ◯ |
| Rust resistance | ◯ | ◯ | ◯ | ◯ | X | X | X | X |

*NV represents a nonvolatile component.

As presented in Table 1, it has been confirmed that both of adhesive property and rust resistance are favorable in Examples 1 to 4 in which either of aluminum tripolyphosphate or magnesium phosphate has been blended as a rust preventive.

However, it has been confirmed that rust resistance is inferior although adhesive property is favorable in Comparative Example 1 in which zinc phosphate other than aluminum tripolyphosphate or magnesium phosphate has been blended as a rust preventive. In addition, it has been confirmed that rust resistance is inferior although adhesive property is favorable in Comparative Examples 2 and 3 in which a rust preventive has not been added. In the same manner, it has been confirmed that rust resistance is inferior although adhesive property is favorable in Comparative Example 4 in which a rust preventive and an inorganic filler have not been blended.

From these results, it has been confirmed that an adhesive composition for steel plate capable of exerting rust resistance even on the cut surface while maintaining adhesive property and a thermoplastic resin-coated steel plate in which a steel plate is bonded with the cured film or film of a thermoplastic resin by this adhesive composition are obtained in Examples 1 to 4.

### INDUSTRIAL APPLICABILITY

According to the adhesive composition for steel plate of the invention, an adhesive composition for steel plate capable of exerting rust resistance even on the cut surface while maintaining adhesive property and a thermoplastic resin-coated steel plate in which a steel plate is bonded with the cured film or film of a thermoplastic resin by this adhesive composition are provided.

1. An adhesive composition for steel plate comprising: a rust preventive; a thermoplastic resin; and a thermosetting resin, wherein
the rust preventive is either of aluminum tripolyphosphate or magnesium phosphate,
the thermoplastic resin is an acrylic resin, and
the thermosetting resin is a phenol resin and an epoxy resin.

2. The adhesive composition for steel plate according to claim 1, wherein a content of aluminum tripolyphosphate or magnesium phosphate is in a range of from 14.0% by mass to 25.0% by mass with respect to a total nonvolatile component amount of the adhesive composition for steel plate.

3. A thermoplastic resin-coated steel plate, wherein a steel plate is bonded with a cured film or film of a thermoplastic resin via the adhesive composition for steel plate according to claim 1.

4. A thermoplastic resin-coated steel plate, wherein a steel plate is bonded with a cured film or film of a thermoplastic resin via the adhesive composition for steel plate according to claim 2.
